(19) United States
(12) Patent Application Publication
(10) Pub. No.: US 2024/0246163 A1
(43) Pub. Date: Jul. 25, 2024

(54) Low-Profile Pipe Cutter

(71) Applicant: Jeffry William Strahan, Ferron, UT (US)

(72) Inventor: Jeffry William Strahan, Ferron, UT (US)

(21) Appl. No.: 18/423,115

(22) Filed: Jan. 25, 2024

Related U.S. Application Data
(60) Provisional application No. 63/481,493, filed on Jan. 25, 2023.

(51) Int. Cl. B23K 9/013

(52) U.S. Cl. CPC B23K 9/013

(57) ABSTRACT

The low-profile pipe cutter has a main body, a barrel torch, and inlet ports. The main body has track wheels, a propulsion system, and a torch attachment area. The barrel torch has an adjustable torch attachment and a torch tip. The main body has a low profile to easily navigate the surrounding area around a pipe. The main body attaches to the outer diameter of an external pipe with an outer diameter of at least 4 and ⅝″. The barrel torch integrates within the center front side of the main body to perform a proper weld or cut along a metal surface. The inlet ports integrates within the rear side of the main body. Accordingly, the inlet ports is protected from the external environment surrounding the main body and the present invention.

### FIELD OF THE INVENTION

The present invention relates generally to a low-profile pipe cutter. More specifically, the present invention is a device that is used to prepare a pipe for welding while easily clearing and navigating through tight spaces.

### BACKGROUND OF THE INVENTION

Within the pipe welding industry there is a need for a low-profile pipe cutter which can be used to prepare a pipe for welding whether in the field, in the plant or in the fabrication shop. The need for a low-profile cutter is seen where a device is needed that can circumnavigate a given pipe diameter and clear walls, other pipe that is adjacent or other obstructions that would impede the movement of standard cutters available in the market.

An objective of the present invention is to provide users with a pipe cutter with a low profile that remains attached to the outer diameter of a pipe, to help prepare a pipe for welding. The present invention intends to provide users with a device that can more remotely crawl around a pipe using a chain attachment while staying square to the central axis of the pipe. In order to accomplish that, a preferred embodiment of the present invention comprises a main body, a barrel torch, and a plurality of inlet ports. Thus, the present invention is a low-profile pipe cutter that easily traverses and navigates through tight spaces without sacrificing pipe welding preparation efficiency.

### BRIEF DESCRIPTION OF THE DRAWINGS

FIG. 1 is a top front right perspective view of the present invention.

FIG. 2 is a top front left perspective view of the present invention.

FIG. 3 is a bottom rear right perspective view of the present invention.

FIG. 4 is a bottom rear left perspective view of the present invention.

FIG. 5 is a front view of the present invention.

FIG. 6 is a rear view of the present invention with the chain attached.

FIG. 7 is a right-side view of the present invention.

FIG. 8 is a left-side view of the present invention.

FIG. 9 is a top view of the present invention.

FIG. 10 is a bottom view of the present invention.

FIG. 11 is a top rear right perspective view of the present invention with the chain attached.

FIG. 12 is a block diagram of the present invention.

### DETAIL DESCRIPTIONS OF THE INVENTION

All illustrations of the drawings are for the purpose of describing selected versions of the present invention and are not intended to limit the scope of the present invention.

The present invention is a low-profile pipe cutter that prepares a pipe for welding. The present invention seeks to provide users with a device that can easily navigate tight spaces where attempting to prepare a pipe for welding would be impractical for a human. In order to accomplish this the present invention comprises a main body 1 with a curved bottom surface to ensure the present invention stays square to the central axis of the pipe. Further, the barrel torch 2 is designed to create an even cut around the diameter of the pipe the present invention is attached to. Additionally, the plurality of inlet ports 3 supplies the present invention with the gas required to operate the barrel torch 2.

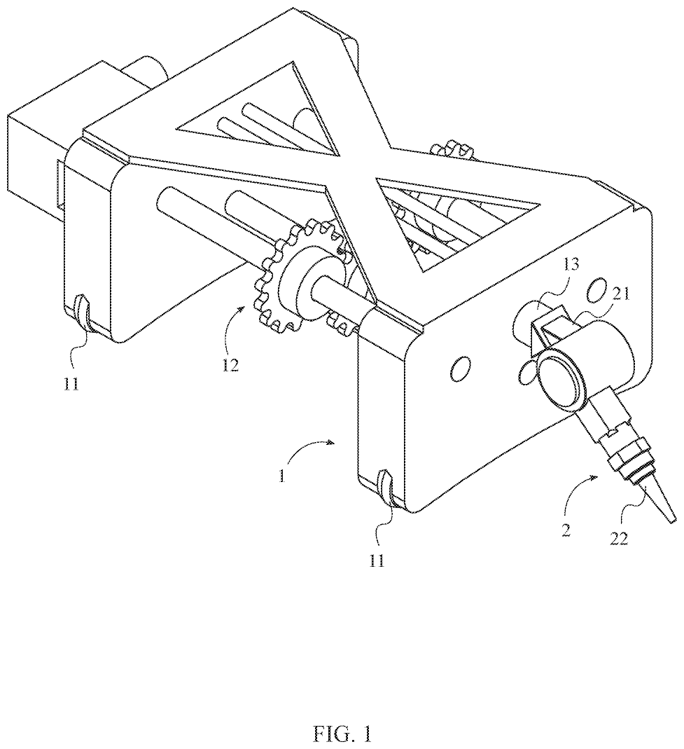

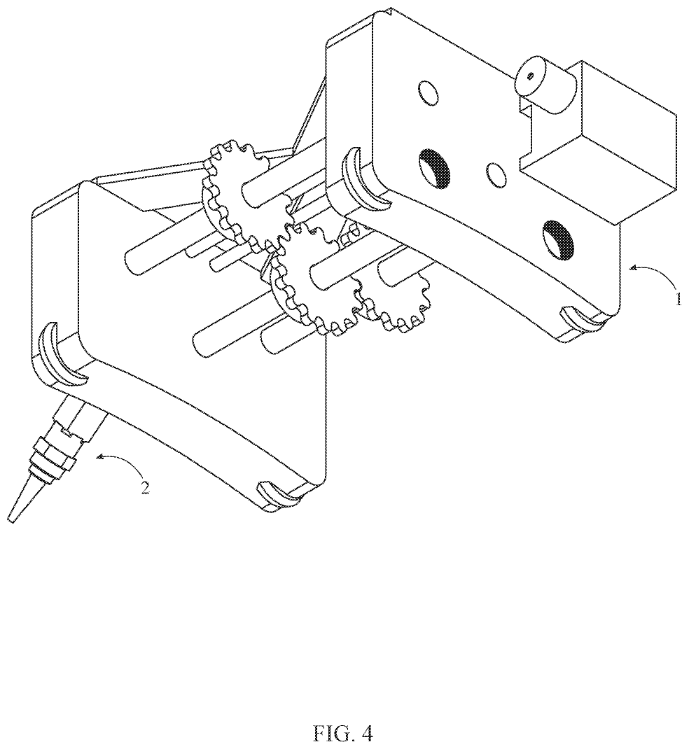

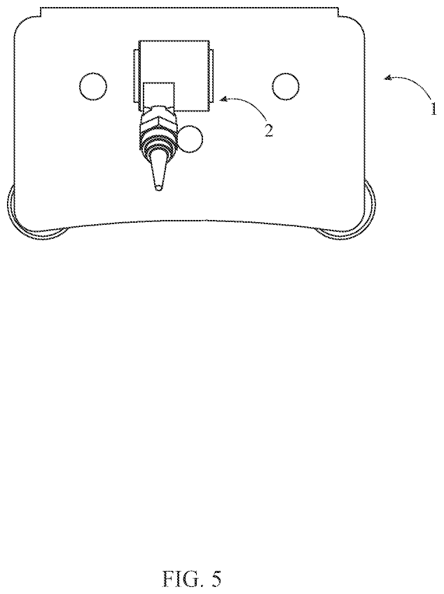

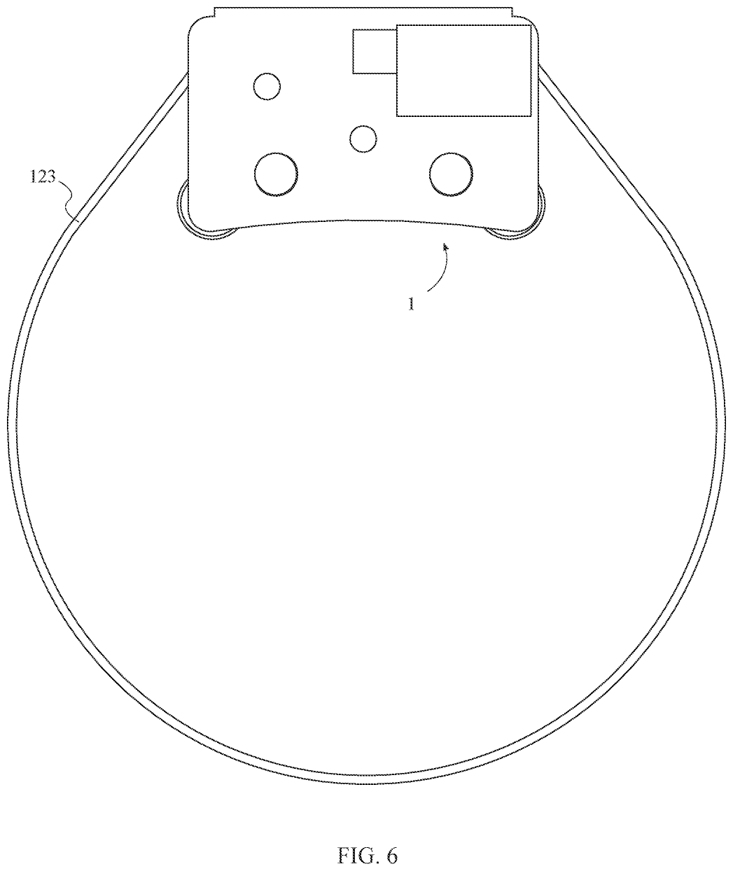

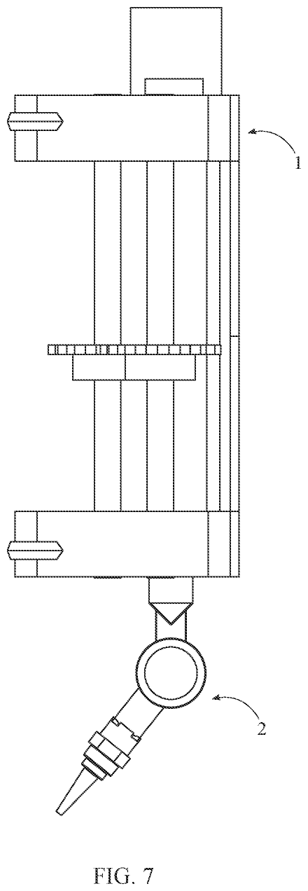

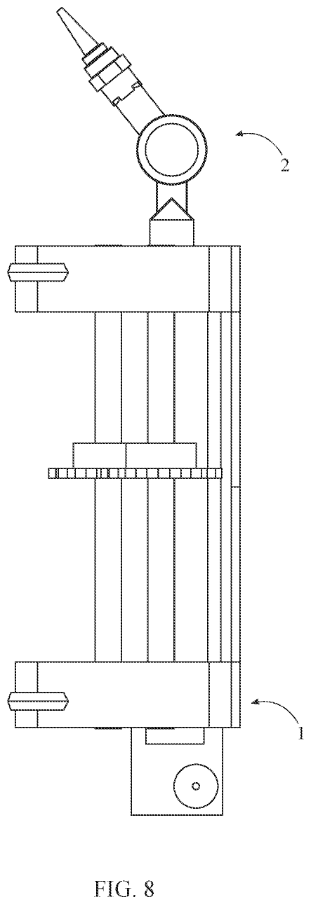

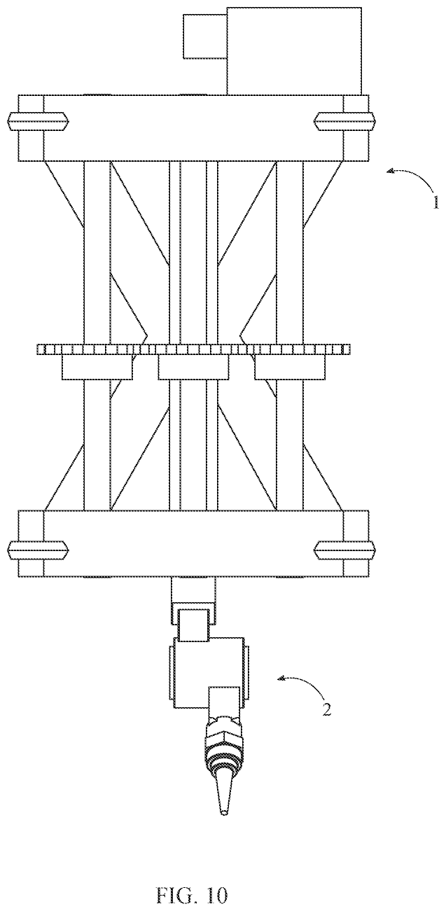

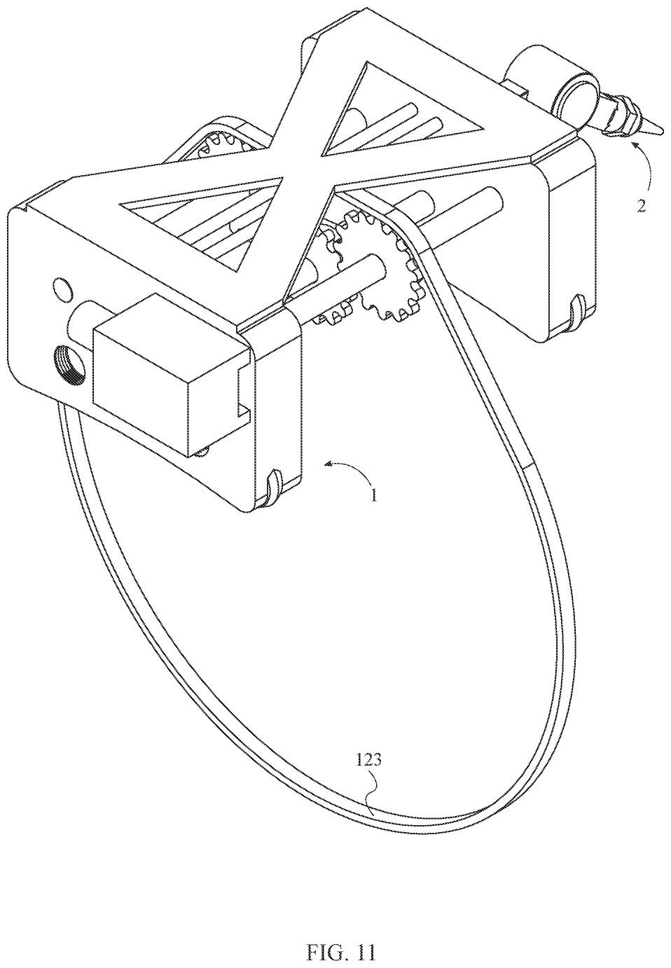

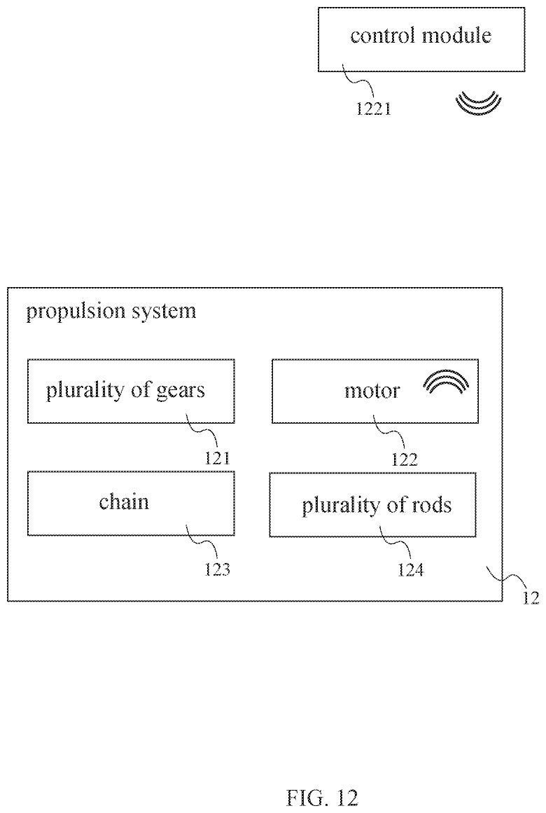

As shown in FIG. 1-12, the present invention is a pipe cutter with a lower profile that can remain attached to the outer diameter of a pipe ranging from 4 and ⅝″ to an unlimited outer diameter. An objective of the present invention is to provide users with a low-profile pipe cutter that is remotely controlled to navigate the surrounding area around a pipe to position the present invention correctly along a pipe for welding preparation. The present invention intends to provide users with a device that crawls around a pipe while staying square to the pipe central axis to create a straight and continuous cutting line along the pipe outer diameter. To accomplish this the present invention comprises a main body 1, a barrel torch 2, and a plurality of inlet ports 3. Many of these components allow for the user to remotely control the present invention to create a cut around a pipe in preparation for welding. The barrel torch 2 is integrated within the central section of the main body 1 and is secured on top of the main body 1 in an alternative embodiment. The plurality of inlet ports 3 is integrated along the rear side of the main body 1. Thus, the present invention is a low-profile pipe cutter that easily traverses and navigates through tight spaces without sacrificing pipe welding preparation efficiency.

In reference to FIG. 1, the low-profile pipe cutter comprises a main body 1, a barrel torch 2, and a plurality of inlet ports 3. The main body 1 comprises a plurality of track wheels 11, a propulsion system 12, and a torch attachment area 13. The barrel torch 2 comprises an adjustable torch attachment 21 and a torch tip 22. The main body 1 has a low profile. As a result, the main body 1 can easily navigate the surrounding area around a pipe. The main body 1 attaches to the outer diameter of an external pipe with an outer diameter of at least 4 and ⅝″. The barrel torch 2 integrates within the center front side of the main body 1. Consequently, the barrel torch 2 is positioned along the front side of the present invention in a position to perform a proper weld or cut along a metal surface. The plurality of inlet ports 3 integrates within the rear side of the main body 1. Accordingly, the plurality of inlet ports 3 is protected from the external environment surrounding the main body 1 and the present invention.

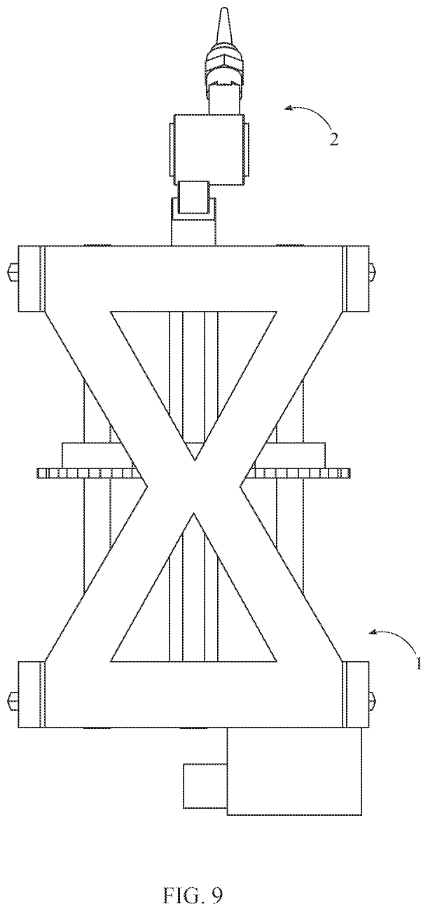

In reference to FIG. 9, the main body 1 has a rectangular shape. The main body 1 has a curved bottom side. Thus, the main body 1 can easily rotate around the outer diameter of an external pipe. The main body 1 is a durable metal material. So, the main body 1 can withstand the environment of the pipelining and pipe fabrication business. The main body 1 can withstand and not be damaged by the high heat of the cutting flame or plasma stream.

The plurality of track wheels 11 integrates along the bottom side of the main body 1 as shown in FIG. 1. The plurality of track wheels 11 is spaced evenly along the curve of the bottom side of the main body 1. As a result, each of the track wheels is placed in a corner of the rectangular shape of the main body 1. The plurality of track wheels 11 has a circular shape. Consequently, each of the track wheels can rotate around a central point and function as a wheel. The plurality of track wheels 11 secures to the main body 1 at the center of each of the track wheels. Accordingly, the center of each of the track wheels is secured to the main body 1. The plurality of track wheels 11 rotates around the center of each of the track wheels. Thus, the plurality of track wheels 11 can rotate in place around the center of each of the track wheels. The plurality of track wheels 11 provides frictional force along the outer circumference of each of the track wheels. So, the plurality of track wheels 11 grip to the outer surface of the external pipe without creating unwanted cuts or scratches on the external pipe the present invention is attached to. The plurality of track wheels 11 dispersing the weight of the main body 1 along an external pipe. As a result, the main body 1 does not exert too much pressure along a centralized point on the external pipe and spreads out the weight of the present invention along the external pipe.

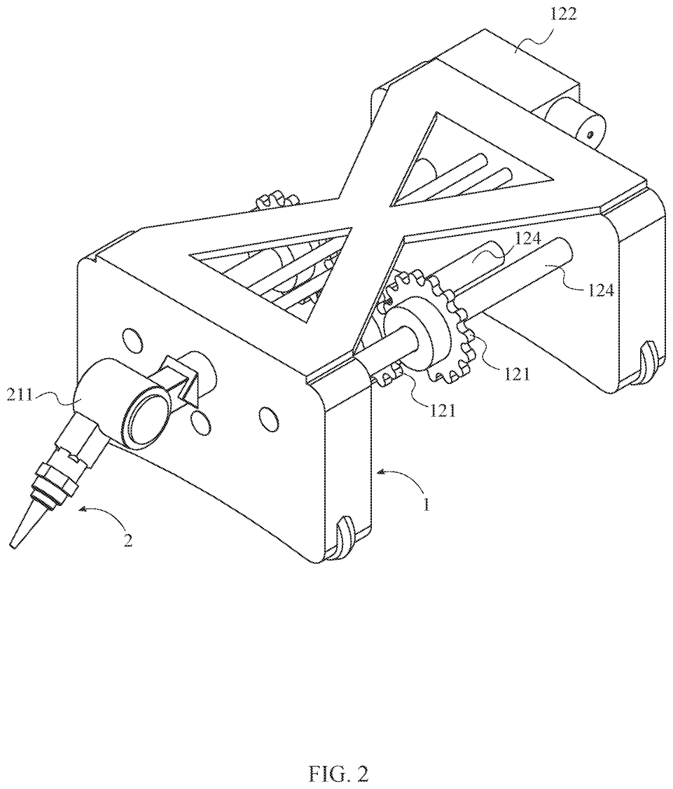

Further, the propulsion system 12 integrates into the center of the main body 1. The propulsion system 12 further comprises a plurality of gears 121, a motor 122, a chain 123, and a plurality of rods 124 as seen in FIG. 2. The plurality of rods 124 traverses from the front end of the main body 1 to the rear end of the main body 1. Consequently, the plurality of rods 124 connects the front of the main body 1 to the rear of the main body 1 along with an X-shaped cross-bracing. The plurality of rods 124 is a metal material. The plurality of rods 124 rotates around the central axis of each of the rods. Accordingly, the plurality of rods 124 has a cylindrical shape that freely rotates around each central axis of the plurality of rods 124 allowing each of the rods to rotate in place independently within the main body 1. The plurality of gears 121 attaches along the length of the plurality of rods 124. Thus, the plurality of gears 121 is positioned centrally on the plurality of rods 124. The plurality of gears 121 integrates to the plurality of rods 124. Each of the gears is mechanically coupled to the rest of the plurality of gears 121. So, the plurality of gears 121 rotates simultaneously with the plurality of rods 124 and each gear rotates any mechanically connected gear. The plurality of gears 121 allows for one moving gear to rotate the rest of the attached plurality of gears 121.

Furthermore, the motor 122 connects to the end of one of the plurality of rods 124 as seen in FIG. 2. As a result, the motor 122 mechanically rotates at least one rod. The motor 122 further comprises a control module 1221. The motor 122 is a DC drive motor 122 that creates a torque force on at least one of the plurality of rods 124 to ensure the propulsion system 12 properly rotates. The control module 1221 is equipped with a potentiometer and remote device to allow the motor 122 to be controlled by a remote handheld device. The control module 1221 controls the speed and direction of the motor 122. Consequently, the control module 1221 can cause the present invention to move around the external pipe in two directions and at varying speeds. The control module 1221 is remotely controlled by the user. Accordingly, the user controls the control module 1221 remotely with a hand crank or motorized crank to ensure the present invention has accessibility to small areas around an external pipe. The chain 123 is mechanically coupled to the plurality of gears 121. Thus, the plurality of gears 121 interlocks with the chain 123. The chain 123 wraps around the external pipe. The chain 123 is a flexible series of linked metal members. The chain 123 adjusts to the diameter of the external pipe. So, the chain 123 fits snuggly around an external pipe and main body 1 to ensure the present invention can navigate around an external pipe. The plurality of gears 121 moves along the length of the chain 123. As a result, the plurality of gears 121 can navigate 360 degrees around an external pipe to create a weld or cut.

In reference to FIG. 1, the torch attachment area 13 is integrated along the front side of the main body 1. The torch attachment area 13 has a circular shape. The torch attachment area 13 has a threaded inner wall to receive male threaded connections. Consequently, the torch attachment area 13 is designed to receive the barrel torch 2.

In reference to FIG. 2, the barrel torch 2 is a metal material. The barrel torch 2 has a short length with respect to the main body 1 length. Accordingly, the barrel torch 2 maintains a low profile for the present invention. The adjustable torch attachment 21 directs the barrel torch 2 in a desired direction. Thus, the adjustable torch is a metal torch extension that directs the flame in a desired direction. The adjustable torch attachment 21 further comprises a hinge 211 and a threaded connection. The threaded connection secures the adjustable torch attachment 21 to the main body 1. So, the threaded connection allows the adjustable torch attachment 21 to screw into the main body 1. The hinge 211 bends the adjustable torch attachment 21 upwards or downwards. As a result, the hinge 211 is designed to create a desired angle to direct a flame towards the external pipe. The torch tip 22 is secured along the end of the adjustable torch. The torch tip 22 is a hollow conical shape. Consequently, the torch tip 22 directs and concentrates the flame from the barrel torch 2 to a desired point. This design also allows for the adjustable torch attachment 21 to be easily removed for cleaning, adjusting, or replacing.

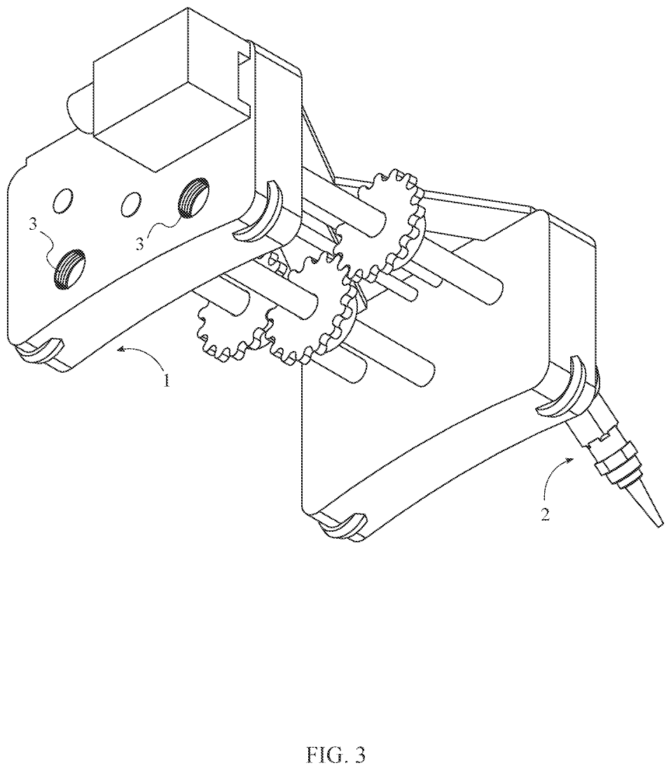

Furthermore, the plurality of inlet ports 3 connects the barrel torch 2 with an external fuel source. Accordingly, the barrel torch 2 is provided with the necessary fuel to operate properly. The plurality of inlet ports 3 receives a standard torch hose fitting. Thus, the plurality of inlet ports 3 can receive standard torch hose fittings that are equipped with both threaded and quick connect fittings. The plurality of inlet ports 3 attaches to a drilled gas port way and a lined gas port way. So, the plurality of inlet ports 3 feed to the barrel torch 2 and adjustable torch attachment 21 positioned on the opposite side of the main body 1 as seen in FIG. 3. This design ensures the barrel torch 2 is provided with the proper amount of pressurized gases for the cutting operation. The plurality of inlet ports 3 is integrated within the main body 1. As a result, the plurality of inlet ports 3 is properly protected from external damage. The plurality of inlet ports 3 further comprises a valve. The valve controls the incoming oxygen and fuel lines and allows for the proper adjustments to be made to produce the proper flame for cutting.

Although the invention has been explained in relation to its preferred embodiment, it is to be understood that many other possible modifications and variations can be made without departing from the spirit and scope of the invention as hereinafter claimed.

What is claimed is:

1. A low-profile pipe cutter comprising:
a main body;
a barrel torch;
a plurality of inlet ports;
the main body comprising a plurality of track wheels, a propulsion system, and a torch attachment area;
the barrel torch comprising an adjustable torch attachment and a torch tip;
the main body having a low profile;
the main body attaching to the outer diameter of an external pipe with an outer diameter of at least 4 and ⅝″;
the barrel torch integrating within the center front side of the main body; and
the plurality of inlet ports integrating within the rear side of the main body.

2. The low-profile pipe cutter as claimed in claim 1 comprising:
the main body having a rectangular shape;
the main body having a curved bottom side; and
the main body being a durable metal material.

3. The low-profile pipe cutter as claimed in claim 2 comprising:
the plurality of track wheels integrating along the bottom side of the main body;
the plurality of track wheels being spaced evenly along the curve of the bottom side of the main body;
the plurality of track wheels having a circular shape;
the plurality of track wheels securing to the main body at the center of each of the track wheels;
the plurality of track wheels rotating around the center of each of the track wheels;
the plurality of track wheels providing frictional force along the outer circumference of each of the track wheels; and
the plurality of track wheels dispersing the weight of the main body along an external pipe.

4. The low-profile pipe cutter as claimed in claim 2 comprising:
the propulsion system integrating into the center of the main body; and
the propulsion system further comprising a plurality of gears, a motor, a chain, and a plurality of rods.

5. The low-profile pipe cutter as claimed in claim 4 comprising:
the plurality of rods traversing from the front end of the main body to the rear end of the main body;
the plurality of rods being a metal material; and
the plurality of rods rotating around the central axis of each of the rods.

6. The low-profile pipe cutter as claimed in claim 4 comprising:
the plurality of gears attaching along the length of the plurality of rods;
the plurality of gears integrating to the plurality of rods; and
each of the gears being mechanically coupled to the rest of the plurality of gears.

7. The low-profile pipe cutter as claimed in claim 4 comprising:
the motor connecting to the end of one of the plurality of rods;
the motor further comprising a control module;
the control module controlling the speed and direction of the motor; and
the control module being remotely controlled by the user.

8. The low-profile pipe cutter as claimed in claim 4 comprising:
the chain being mechanically coupled to the plurality of gears;
the chain wrapping around the external pipe;
the chain adjusting to the diameter of the external pipe; and
the plurality of gears moving along the length of the chain.

9. The low-profile pipe cutter as claimed in claim 2 comprising:
the torch attachment area being integrated along the front side of the main body;
the torch attachment area having a circular shape; and
the torch attachment area having a threaded inner wall to receive male threaded connections.

10. The low-profile pipe cutter as claimed in claim 1 comprising:
the barrel torch being a metal material;
the barrel torch having a short length with respect to the main body length;
the adjustable torch attachment directing the barrel torch in a desired direction;
the adjustable torch attachment further comprising a hinge and a threaded connection;
the threaded connection securing the adjustable torch attachment to the main body;
the hinge bending the adjustable torch attachment upwards or downwards;
the torch tip being secured along the end of the adjustable torch; and
the torch tip being a hollow conical shape.

11. The low-profile pipe cutter as claimed in claim 1 comprising:
the plurality of inlet ports connecting the barrel torch with an external fuel source;
the plurality of inlet ports receiving a standard torch hose fitting;
the plurality of inlet ports attaching to a drilled gas port way and a lined gas port way;
the plurality of inlet ports being integrated within the main body; and
the plurality of inlet ports further comprising a valve.

12. A low-profile pipe cutter comprising:
a main body;
a barrel torch;
a plurality of inlet ports;
the main body comprising a plurality of track wheels, a propulsion system, and a torch attachment area;
the barrel torch comprising an adjustable torch attachment and a torch tip;
the main body having a low profile;
the main body attaching to the outer diameter of an external pipe with an outer diameter of at least 4 and ⅝″;
the barrel torch integrating within the center front side of the main body;
the plurality of inlet ports integrating within the rear side of the main body;
the main body having a rectangular shape;
the main body having a curved bottom side;
the main body being a durable metal material;
the plurality of track wheels integrating along the bottom side of the main body;
the plurality of track wheels being spaced evenly along the curve of the bottom side of the main body;
the plurality of track wheels having a circular shape;
the plurality of track wheels securing to the main body at the center of each of the track wheels;
the plurality of track wheels rotating around the center of each of the track wheels;
the plurality of track wheels providing frictional force along the outer circumference of each of the track wheels; and
the plurality of track wheels dispersing the weight of the main body along an external pipe.

13. The low-profile pipe cutter as claimed in claim 12 comprising:
the propulsion system integrating into the center of the main body;
the propulsion system further comprising a plurality of gears, a motor, a chain, and a plurality of rods;
the plurality of rods traversing from the front end of the main body to the rear end of the main body;
the plurality of rods being a metal material;
the plurality of rods rotating around the central axis of each of the rods;
the plurality of gears attaching along the length of the plurality of rods;
the plurality of gears integrating to the plurality of rods;
each of the gears being mechanically coupled to the rest of the plurality of gears;
the motor connecting to the end of one of the plurality of rods;
the motor further comprising a control module;
the control module controlling the speed and direction of the motor;
the control module being remotely controlled by the user;
the chain being mechanically coupled to the plurality of gears;
the chain wrapping around the external pipe;
the chain adjusting to the diameter of the external pipe; and
the plurality of gears moving along the length of the chain.

14. The low-profile pipe cutter as claimed in claim 12 comprising:
the torch attachment area being integrated along the front side of the main body;
the torch attachment area having a circular shape; and
the torch attachment area having a threaded inner wall to receive male threaded connections.

15. The low-profile pipe cutter as claimed in claim 12 comprising:
the barrel torch being a metal material;
the barrel torch having a short length with respect to the main body length;
the adjustable torch attachment directing the barrel torch in a desired direction;
the adjustable torch attachment further comprising a hinge and a threaded connection;
the threaded connection securing the adjustable torch attachment to the main body;
the hinge bending the adjustable torch attachment upwards or downwards;
the torch tip being secured along the end of the adjustable torch; and
the torch tip being a hollow conical shape.

16. The low-profile pipe cutter as claimed in claim 12 comprising:
the plurality of inlet ports connecting the barrel torch with an external fuel source;
the plurality of inlet ports receiving a standard torch hose fitting;
the plurality of inlet ports attaching to a drilled gas port way and a lined gas port way;
the plurality of inlet ports being integrated within the main body; and
the plurality of inlet ports further comprising a valve.

17. A low-profile pipe cutter comprising:
a main body;
a barrel torch;
a plurality of inlet ports;
the main body comprising a plurality of track wheels, a propulsion system, and a torch attachment area;
the barrel torch comprising an adjustable torch attachment and a torch tip;
the main body having a low profile;
the main body attaching to the outer diameter of an external pipe with an outer diameter of at least 4 and ⅝″;
the barrel torch integrating within the center front side of the main body;
the plurality of inlet ports integrating within the rear side of the main body;
the main body having a rectangular shape;
the main body having a curved bottom side;
the main body being a durable metal material;
the plurality of track wheels integrating along the bottom side of the main body;
the plurality of track wheels being spaced evenly along the curve of the bottom side of the main body;
the plurality of track wheels having a circular shape;
the plurality of track wheels securing to the main body at the center of each of the track wheels;
the plurality of track wheels rotating around the center of each of the track wheels;
the plurality of track wheels providing frictional force along the outer circumference of each of the track wheels;
the plurality of track wheels dispersing the weight of the main body along an external pipe;
the propulsion system integrating into the center of the main body; and
the propulsion system further comprising a plurality of gears, a motor, a chain, and a plurality of rods.

18. The low-profile pipe cutter as claimed in claim 17 comprising:
the plurality of rods traversing from the front end of the main body to the rear end of the main body;
the plurality of rods being a metal material;
the plurality of rods rotating around the central axis of each of the rods;
the plurality of gears attaching along the length of the plurality of rods;
the plurality of gears integrating to the plurality of rods;
each of the gears being mechanically coupled to the rest of the plurality of gears;
the motor connecting to the end of one of the plurality of rods;
the motor further comprising a control module;
the control module controlling the speed and direction of the motor;
the control module being remotely controlled by the user;
the chain being mechanically coupled to the plurality of gears;
the chain wrapping around the external pipe;
the chain adjusting to the diameter of the external pipe;
the plurality of gears moving along the length of the chain;
the torch attachment area being integrated along the front side of the main body;
the torch attachment area having a circular shape; and
the torch attachment area having a threaded inner wall to receive male threaded connections.

19. The low-profile pipe cutter as claimed in claim 17 comprising:
the barrel torch being a metal material;
the barrel torch having a short length with respect to the main body length;
the adjustable torch attachment directing the barrel torch in a desired direction;
the adjustable torch attachment further comprising a hinge and a threaded connection;
the threaded connection securing the adjustable torch attachment to the main body;
the hinge bending the adjustable torch attachment upwards or downwards;
the torch tip being secured along the end of the adjustable torch; and
the torch tip being a hollow conical shape.

20. The low-profile pipe cutter as claimed in claim 17 comprising:
the plurality of inlet ports connecting the barrel torch with an external fuel source;
the plurality of inlet ports receiving a standard torch hose fitting;
the plurality of inlet ports attaching to a drilled gas port way and a lined gas port way;
the plurality of inlet ports being integrated within the main body; and
the plurality of inlet ports further comprising a valve.
